(19) United States
(12) Patent Application Publication
(10) Pub. No.: US 2010/0124989 A1
(43) Pub. Date: May 20, 2010

(54) Gaming System Having Multiple Wager Levels Eligible For Progressive Jackpots

(75) Inventors: Allon G. Englman, Chicago, IL (US); Michael W. Mastropietro, Chicago, IL (US); Dylan B. SeLegue, Chicago, IL (US)

Correspondence Address: NIXON PEABODY LLP, 300 S. Riverside Plaza, 16th Floor, CHICAGO, IL, 60606, US

(73) Assignee: WMS Gaming Inc., Waukegan, IL (US)

(21) Appl. No.: 12/617,476

(22) Filed: Nov. 12, 2009

Related U.S. Application Data
(60) Provisional application No. 61/199,347, filed on Nov. 14, 2008.

(51) Int. Cl. G06F 19/00; A63F 9/24

(52) U.S. Cl. 463/27; 463/42

(57) ABSTRACT

A method of conducting a wagering game having a scaled progressive award comprises receiving a first wager from a player, displaying a first play of a primary wagering game, and calculating an increment of the first wager in accordance with an increment rate. If the first wager is equal to a minimum wager, the increment is deposited into a first bin. If the first wager is greater than a minimum wager, a first portion of the increment is deposited into the first bin and a second portion of the increment is deposited into a second bin. Upon the occurrence of a triggering event, a scaled progressive award is awarded, comprising a sum of a reset value, the first bin, and any additional bins for which the player qualifies.

### CROSS REFERENCE TO RELATED APPLICATION

This application is related to and claims priority to U.S. Provisional Application No. 61/199,347 filed Nov. 14, 2008, titled “Gaming System Having Multiple Wager Levels Eligible For Progressive Jackpots,” which is incorporated herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus, and methods for playing wagering games, and more particularly, to a gaming system having multiple wager levels eligible for progressive awards.

### BACKGROUND OF THE INVENTION

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Therefore, there is a continuing need for gaming machine manufacturers to continuously develop new games and improved gaming enhancements that will attract frequent play through enhanced entertainment value to the player.

One way to enhance the entertainment value of game is to provide a gaming system having progressive awards which may be funded by a portion of wagers received into the system for play of wagering games. To ensure perceived equality and fairness, a gaming system, as described herein, may include accounting and funding mechanisms which permit players wagering different amounts on primary wagering games to be eligible for progressive awards. Thus, the present invention is directed to a gaming system having multiple wager levels eligible for progressive awards.

### SUMMARY OF THE INVENTION

According to one aspect of the present invention, a method of conducting a wagering game having a scaled progressive award comprises receiving a first wager from a player, displaying a first play of a primary wagering game, and calculating an increment of the first wager in accordance with an increment rate. If the first wager is equal to a minimum wager, the increment is deposited into a first bin. If the first wager is greater than a minimum wager, a first portion of the increment is deposited into the first bin and a second portion of the increment is deposited into a second bin. Upon the occurrence of a triggering event, a scaled progressive award is awarded, comprising a sum of a reset value, the first bin, and any additional bins for which the player qualifies.

According to another aspect of the invention, a method of conducting a wagering game having a scaled progressive award comprises receiving a first wager from a player, the first wager selected from a group of N available wager amounts, displaying a first play of a primary wagering game, and calculating an increment of the first wager in accordance with an increment rate. If the first wager is equal to a minimum wager, the increment is deposited into a first bin of N bins. If the first wager is greater than a minimum wager, a first portion of the increment is deposited into the first bin and a remainder of the increment is deposited into at least one of the remaining N bins. The method further comprises, upon the occurrence of a triggering event, (i) determining a size of a second wager placed on a subsequent play of the wagering game during which the triggering event occurred, and (ii) awarding a scaled progressive award, the scaled progressive award dependent upon the size of the second wager.

According to yet another aspect of the invention, a gaming system comprises a wager input device, at least one display for displaying a primary wagering game and value of a progressive jackpot, and at least one controller. The controller is operative to (i) detect receipt of a first wager from a first player, (ii) cause the at least one display to display a first play of the primary wagering game, (iii) calculate an increment of the first wager in accordance with an increment rate, (iv) if the first wager is equal to a minimum wager, deposit the increment into a first bin, (v) if the first wager is greater than a minimum wager, deposit a first portion of the increment into the first bin and a second portion of the increment into a second bin, and (vi) upon the occurrence of a triggering event, award a scaled progressive award comprising a sum of a reset value, the first bin, and any additional bins for which the player qualifies.

According to yet another aspect of the invention, a gaming system comprises a plurality of gaming terminals, each gaming terminal comprising a display for displaying a primary wagering game, at least one wager input device for receiving wagers from players at the plurality of gaming terminals, at least one community display from displaying a value of a progressive jackpot, and at least one controller. The controller is operative to (i) detect receipt of wagers from the players, each such wager selected from a group of N available wager amounts, (ii) calculate an increment of each wager received in accordance with an increment rate, (iii) if a received wager is equal to a minimum wager, deposit the increment into a first bin of N bins, (iv) if a received wager is greater than a minimum wager, deposit a first portion of the increment into the first bin and a remainder of the increment into at least one of the remaining N bins, (v) upon the occurrence of a triggering event, determine a size of a final wager placed on a subsequent play of the wagering game during which the triggering event occurred, and award a scaled progressive award, the scaled progressive award dependent upon the size of the final wager.

According to yet another aspect of the invention, a computer readable storage medium is encoded with instructions for directing a gaming system to perform the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1a is a perspective view of a free-standing gaming terminal according to an embodiment of the present invention.

FIG. 1b is a perspective view of a handheld gaming terminal according to an embodiment of the present invention.

FIG. 2 is a schematic view of a gaming system according to an embodiment of the present invention.

FIG. 3 is an image of a basic-game screen of a wagering game that may be displayed on a gaming terminal, according to an embodiment of the present invention.

FIG. 4 is an image of a bonus-game screen of a wagering game that may be displayed on a gaming terminal, according to an embodiment of the present invention.

FIG. 5 is a depiction of a gaming system including a plurality of gaming terminals and a community display displaying at least one progressive jackpot.

FIG. 6 is a diagram of an example gaming system including a progressive jackpot controller server for administering system at least one progressive jackpot for which multiple wager levels are eligible.

FIG. 7 is an image of a primary display of a gaming terminal of a gaming system including a plurality of player input devices comprising a plurality of wager buttons.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

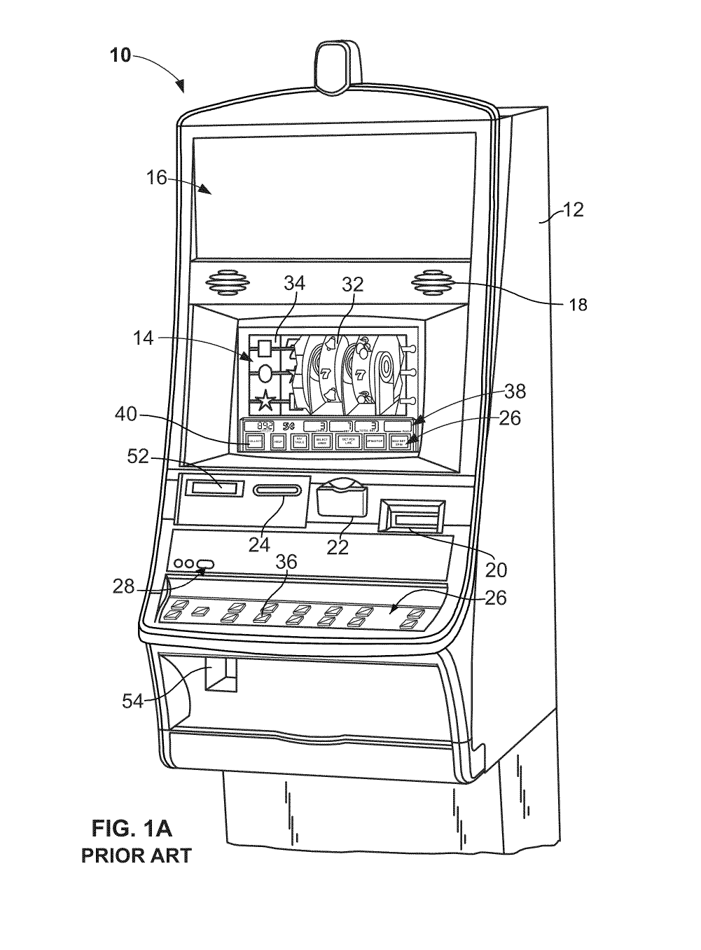

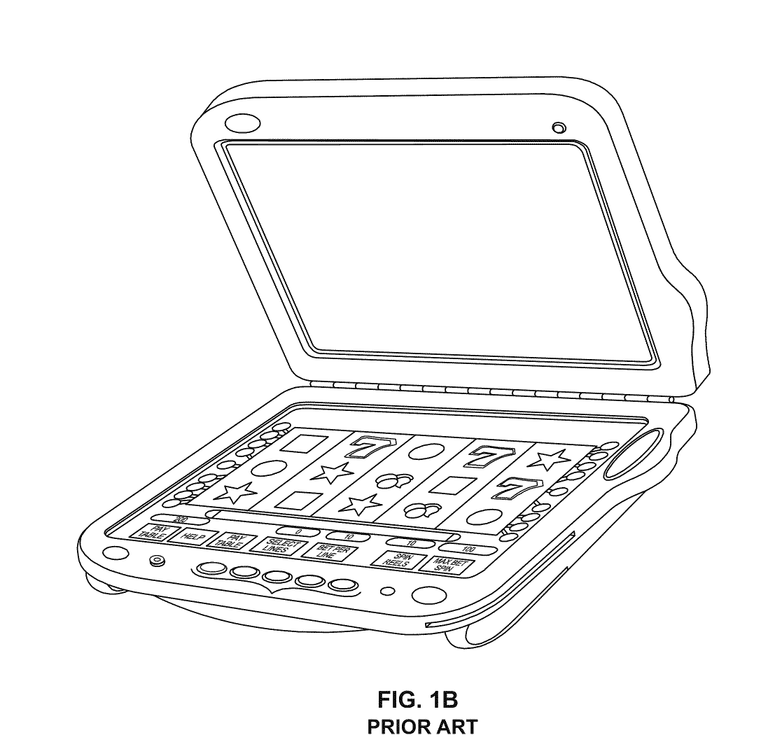

Referring to FIG. 1a, there is shown a gaming terminal 10 similar to those used in gaming establishments, such as casinos. With regard to the present invention, the gaming terminal 10 may be any type of gaming terminal and may have varying structures and methods of operation. For example, the gaming terminal 10 may be an electromechanical gaming terminal configured to play mechanical slots, or it may be an electronic gaming terminal configured to play a video casino game, such as slots, keno, poker, blackjack, roulette, craps, etc. It should be understood that although the gaming terminal 10 is shown as a free-standing terminal of the upright type, it may take on a wide variety of other forms such as a free-standing terminal of the slant-top type, a portable or handheld device primarily used for gaming as shown in FIG. 1b, a mobile telecommunications device such as a mobile telephone or personal digital assistant (PDA), a counter-top or bar-top gaming terminal, or other personal electronic device such as a portable television, MP3 player, entertainment device, etc.

The illustrated gaming terminal 10 comprises a cabinet or housing 12. For output devices, the gaming terminal 10 may include a primary display area 14, a secondary display area 16, and one or more audio speakers 18. The primary display area 14 and/or secondary display area 16 may display information associated with wagering games, non-wagering games, community games, progressives, advertisements, services, premium entertainment, text messaging, emails, alerts or announcements, broadcast information, subscription information, etc. For input devices, the gaming terminal 10 may include a bill validator 20, a coin acceptor 22, one or more information readers 24, one or more player-input devices 26, and one or more player-accessible ports 28 (e.g., an audio output jack for headphones, a video headset jack, a wireless transmitter/receiver, etc.). While these typical components found in the gaming terminal 10 are described below, it should be understood that numerous other peripheral devices and other elements may exist and may be used in any number of combinations to create various forms of a gaming terminal.

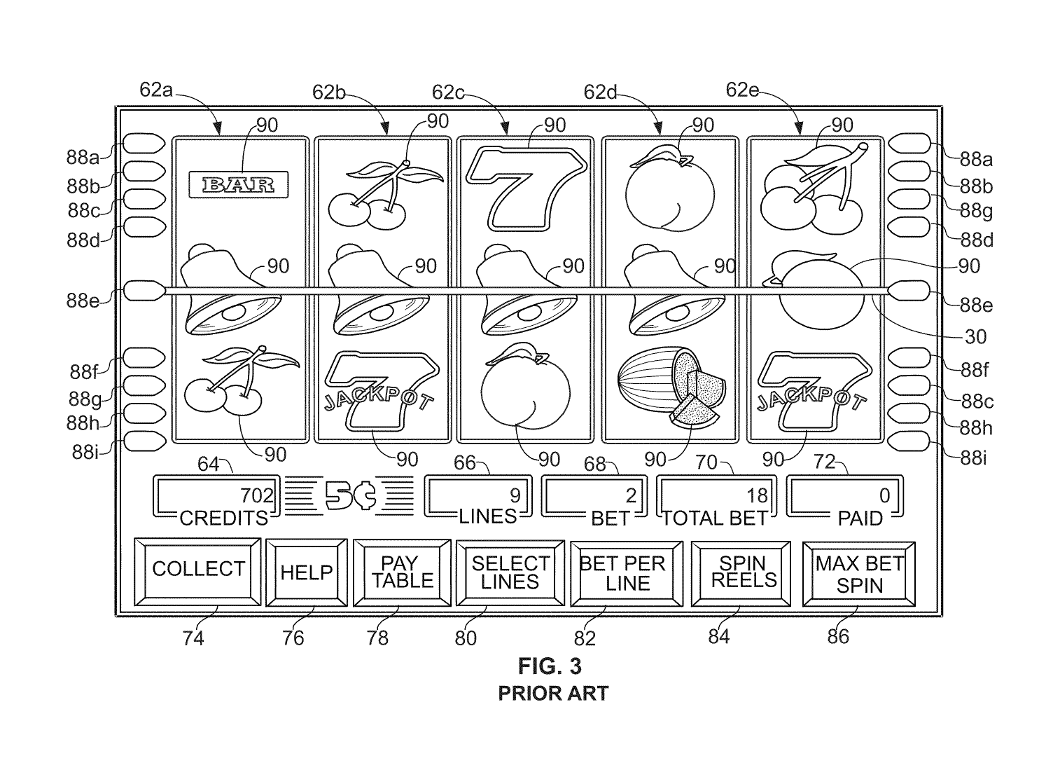

The primary display area 14 may include a mechanical-reel display, a video display, or a combination thereof in which a transmissive video display in front of the mechanical-reel display portrays a video image superimposed over the mechanical-reel display. Further information concerning the latter construction is disclosed in U.S. Pat. No. 6,517,433 to Loose et al. entitled “Reel Spinning Slot Machine With Superimposed Video Image,” which is incorporated herein by reference in its entirety. The video display may be a cathode ray tube (CRT), a high-resolution liquid crystal display (LCD), a plasma display, a light emitting diode (LED), a DLP projection display, an electroluminescent (EL) panel, or any other type of display suitable for use in the gaming terminal 10. The primary display area 14 may include one or more paylines 30 (see FIG. 3) extending along a portion thereof. In the illustrated embodiment, the primary display area 14 comprises a plurality of mechanical reels 32 and a video display 34 such as a transmissive display (or a reflected image arrangement in other embodiments) in front of the mechanical reels 32. If the wagering game conducted via the gaming terminal 10 relies upon the video display 34 only and not the mechanical reels 32, the mechanical reels 32 may be removed from the interior of the terminal and the video display 34 may be of a non-transmissive type. Similarly, if the wagering game conducted via the gaming terminal 10 relies upon the mechanical reels 32 but not the video display 34, the video display 34 may be replaced with a conventional glass panel. Further, the underlying mechanical-reel display may be replaced with a video display such that the primary display area 14 includes layered video displays, or may be replaced with another mechanical or physical member such as a mechanical wheel (e.g., a roulette game), dice, a pachinko board, or a diorama presenting a three-dimensional model of a game environment.

Video images in the primary display area 14 and/or the secondary display area 16 may be rendered in two-dimensional (e.g., using Flash Macromedia™) or three-dimensional graphics (e.g., using Renderware™). The images may be played back (e.g., from a recording stored on the gaming terminal 10), streamed (e.g., from a gaming network), or received as a TV signal (e.g., either broadcast or via cable). The images may be animated or they may be real-life images, either prerecorded (e.g., in the case of marketing/promotional material) or as live footage, and the format of the video images may be an analog format, a standard digital format, or a high-definition (HD) digital format.

The player-input devices 26 may include a plurality of buttons 36 on a button panel and/or a touch screen 38 mounted over the primary display area 14 and/or the secondary display area 16 and having one or more soft touch keys 40. The player-input devices 26 may further comprise technologies that do not rely upon touching the gaming terminal, such as speech-recognition technology, gesture-sensing technology, eye-tracking technology, etc.

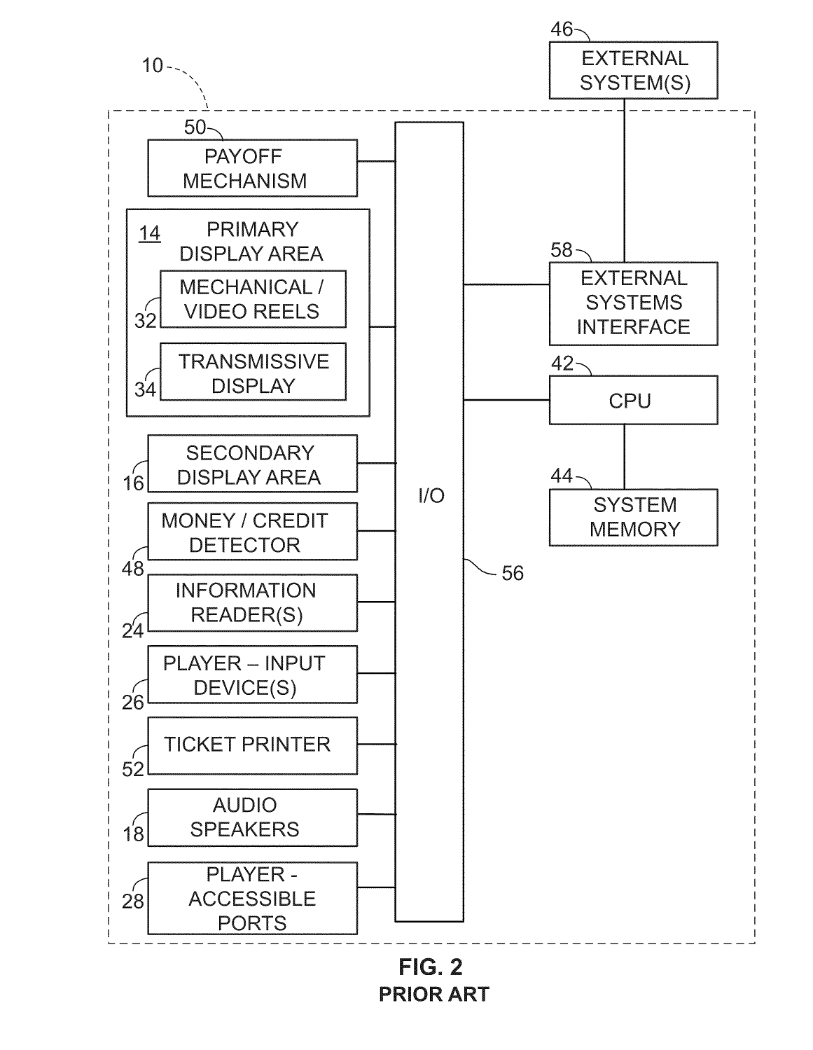

The information reader 24 is preferably located on the front of the housing 12 and may take on many forms such as a ticket reader, card reader, bar code scanner, wireless transceiver (e.g., RFID, Bluetooth, etc.), biometric reader, or computer-readable-storage-medium interface. Information may be transmitted between a portable medium (e.g., ticket, voucher, coupon, casino card, smart card, debit card, credit card, etc.) and the information reader 24 for accessing an account associated with cashless gaming, player tracking, game customization, saved-game state, data transfer, and casino services as more fully disclosed in U.S. Patent Publication No. 2003/0045354 entitled “Portable Data Unit for Communicating With Gaming Machine Over Wireless Link,” which is incorporated herein by reference in its entirety. The account may be stored at an external system 46 (see FIG. 2) as more fully disclosed in U.S. Pat. No. 6,280,328 to Holch et al. entitled “Cashless Computerized Video Game System and Method,” which is incorporated herein by referenced in its entirety, or directly on the portable medium. To enhance security, the individual carrying the portable medium may be required to enter a secondary independent authenticator (e.g., password, PIN number, biometric, etc.) to access their account.

FIG. 1b illustrates a portable or handheld device primarily used to display and/or conduct wagering games. The handheld device may incorporate the same features as the gaming terminal 10 or variations thereof. A more detailed description of a handheld device that may be utilized with the present invention can be found in PCT Patent Application No. PCT/US2007/000792 filed Jan. 26, 2007, entitled “Handheld Device for Wagering Games,” which is incorporated herein by reference in its entirety.

Turning now to FIG. 2, the various components of the gaming terminal 10 are controlled by a central processing unit (CPU) 42, also referred to herein as a controller or processor (such as a microcontroller or microprocessor). The CPU 42 can include any suitable processor, such as an Intel® Pentium processor, Intel® Core 2 Duo processor, AMD Opteron™ processor, or UltraSPARC® processor. To provide gaming functions, the controller 42 executes one or more game programs stored in one or more computer readable storage media in the form of memory 44 or other suitable storage device. The controller 42 uses a random number generator (RNG) to randomly generate a wagering game outcome from a plurality of possible outcomes. Alternatively, the outcome may be centrally determined using either an RNG or pooling scheme at a remote controller included, for example, within the external system 46. It should be appreciated that the controller 42 may include one or more microprocessors, including but not limited to a master processor, a slave processor, and a secondary or parallel processor.

The controller 42 is coupled to the system memory 44 and also to a money/credit detector 48. The system memory 44 may comprise a volatile memory (e.g., a random-access memory (RAM)) and a non-volatile memory (e.g., an EEPROM). The system memory 44 may include multiple RAM and multiple program memories. The money/credit detector 48 signals the processor that money and/or credits have been input via a value-input device, such as the bill validator 20, coin acceptor 22, or via other sources, such as a cashless gaming account, etc. These components may be located internal or external to the housing 12 of the gaming terminal 10 and connected to the remainder of the components of the gaming terminal 10 via a variety of different wired or wireless connection methods. The money/credit detector 48 detects the input of funds into the gaming terminal 10 (e.g., via currency, electronic funds, ticket, card, etc.) that are generally converted into a credit balance available to the player for wagering on the gaming terminal 10. The credit detector 48 detects when a player places a wager (e.g., via a player-input device 26) to play the wagering game, the wager then generally being deducted from the credit balance. The money/credit detector 48 sends a communication to the controller 42 that a wager has been detected and also communicates the amount of the wager.

As seen in FIG. 2, the controller 42 is also connected to, and controls, the primary display area 14, the player-input device 26, and a payoff mechanism 50. The payoff mechanism 50 is operable in response to instructions from the controller 42 to award a payoff to the player in response to certain winning outcomes that might occur in the base game, the bonus game(s), or via an external game or event. The payoff may be provided in the form of money, redeemable points, services or any combination thereof. Such payoff may be associated with a ticket (from a ticket printer 52), portable data unit (e.g., a card), coins, currency bills, accounts, and the like. The payoff amounts distributed by the payoff mechanism 50 are determined by one or more pay tables stored in the system memory 44.

Communications between the controller 42 and both the peripheral components of the gaming terminal 10 and the external system 46 occur through input/output (I/O) circuit 56, which can include any suitable bus technologies, such as an AGTL+ frontside bus and a PCI backside bus. Although the I/O circuit 56 is shown as a single block, it should be appreciated that the I/O circuit 56 may include a number of different types of I/O circuits. Furthermore, in some embodiments, the components of the gaming terminal 10 can be interconnected according to any suitable interconnection architecture (e.g., directly connected, hypercube, etc.).

The I/O circuit 56 is connected to an external system interface 58, which is connected to the external system 46. The controller 42 communicates with the external system 46 via the external system interface 58 and a communication path (e.g., serial, parallel, IR, RC, 10bT, etc.). The external system 46 may include a gaming network, other gaming terminals, a gaming server, a remote controller, communications hardware, or a variety of other interfaced systems or components.

Controller 42, as used herein, comprises any combination of hardware, software, and/or firmware that may be disposed or resident inside and/or outside of the gaming terminal 10 and may communicate with and/or control the transfer of data between the gaming terminal 10 and a bus, another computer, processor, or device and/or a service and/or a network. The controller 42 may comprise one or more controllers or processors. In FIG. 2, the controller 42 in the gaming terminal 10 is depicted as comprising a CPU, but the controller 42 may alternatively comprise a CPU in combination with other components, such as the I/O circuit 56 and the system memory 44. The controller 42 is operable to execute all of the various gaming methods and other processes disclosed herein.

The gaming terminal 10 may communicate with external system 46 (in a wired or wireless manner) such that each terminal operates as a “thin client” having relatively less functionality, a “thick client” having relatively more functionality, or with any range of functionality therebetween (e.g., a “rich client”). In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets may be contained within the gaming terminal 10 (“thick client” gaming terminal), the external systems 46 (“thin client” gaming terminal), or distributed therebetween in any suitable manner (“rich client” gaming terminal).

Referring now to FIG. 3, an image of a basic-game screen 60 adapted to be displayed on the primary display area 14 is illustrated, according to one embodiment of the present invention. A player begins play of a basic wagering game by providing a wager. A player can operate or interact with the wagering game using the one or more player-input devices 26. The controller 42, the external system 46, or both, in alternative embodiments, operate(s) to execute a wagering game program causing the primary display area 14 to display the wagering game that includes a plurality of visual elements.

The basic-game screen 60 may be displayed on the primary display area 14 or a portion thereof. In FIG. 3, the basic-game screen 60 portrays a plurality of simulated movable reels 62a-e. Alternatively or additionally, the basic-game screen 60 may portray a plurality of mechanical reels. The basic-game screen 60 may also display a plurality of game-session meters and various buttons adapted to be actuated by a player.

In the illustrated embodiment, the game-session meters include a “credit” meter 64 for displaying a number of credits available for play on the terminal; a “lines” meter 66 for displaying a number of paylines to be played by a player on the terminal; a “line bet” meter 68 for displaying a number of credits wagered (e.g., from 1 to 5 or more credits) for each of the number of paylines played; a “total bet” meter 70 for displaying a total number of credits wagered for the particular round of wagering; and a “paid” meter 72 for displaying an amount to be awarded based on the results of the particular round's wager. The user-selectable buttons may include a “collect” button 74 to collect the credits remaining in the credits meter 64; a “help” button 76 for viewing instructions on how to play the wagering game; a “pay table” button 78 for viewing a pay table associated with the basic wagering game; a “select lines” button 80 for changing the number of paylines (displayed in the lines meter 66) a player wishes to play; a “bet per line” button 82 for changing the amount of the wager which is displayed in the line-bet meter 68; a “spin reels” button 84 for moving the reels 62a-e; and a “max bet spin” button 86 for wagering a maximum number of credits and moving the reels 62a-e of the basic wagering game. While the gaming terminal 10 allows for these types of player inputs, the present invention does not require them and can be used on gaming terminals having more, less, or different player inputs.

Paylines 30 may extend from one of the payline indicators 88a-i on the left side of the basic-game screen 60 to a corresponding one of the payline indicators 88a-i on the right side of the screen 60. A plurality of symbols 90 is displayed on the plurality of reels 62a-e to indicate possible outcomes of the basic wagering game. A winning combination occurs when the displayed symbols 90 correspond to one of the winning symbol combinations listed in a pay table stored in the memory 44 of the terminal 10 or in the external system 46. The symbols 90 may include any appropriate graphical representation or animation, and may further include a “blank” symbol.

Symbol combinations may be evaluated as line pays or scatter pays. Line pays may be evaluated left to right, right to left, top to bottom, bottom to top, or any combination thereof by evaluating the number, type, or order of symbols 90 appearing along an activated payline 30. Scatter pays are evaluated without regard to position or paylines and only require that such combination appears anywhere on the reels 62a-e. While an embodiment with nine paylines is shown, a wagering game with no paylines, a single payline, or any plurality of paylines will also work with the present invention. Additionally, though an embodiment with five reels is shown, a gaming terminal with any plurality of reels may also be used in accordance with the present invention.

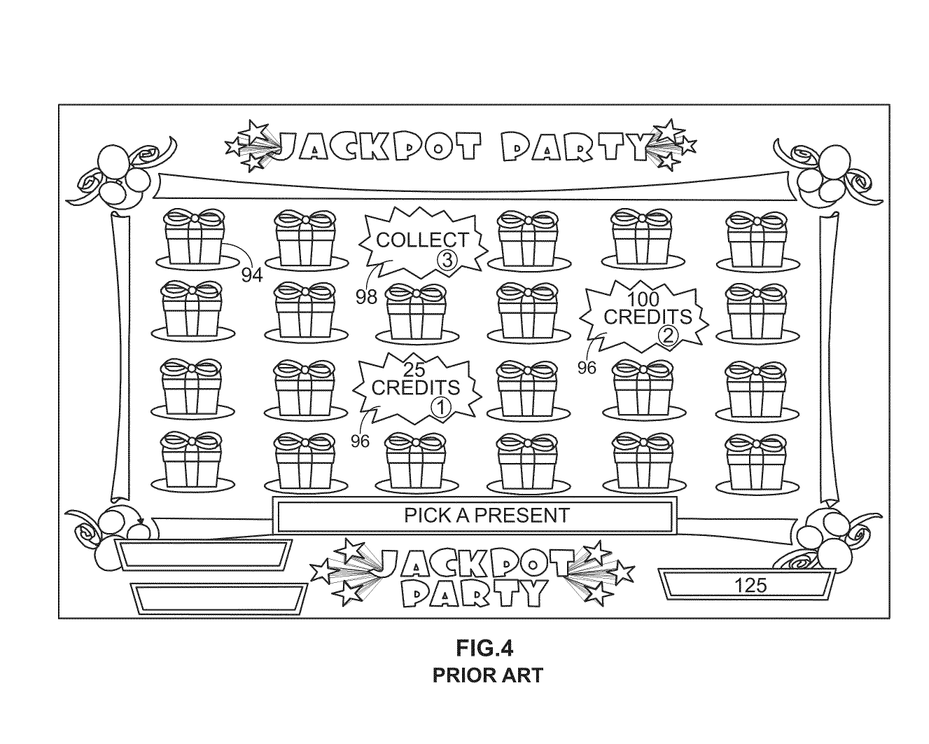

Turning now to FIG. 4, a bonus game that may be included with a basic wagering game is illustrated, according to one embodiment. A bonus-game screen 92 includes an array of markers 94 located in a plurality of columns and rows. The bonus game may be entered upon the occurrence of a special start-bonus game outcome (e.g., symbol trigger, mystery trigger, time-based trigger, etc.) in or during the basic wagering game. Alternatively, the illustrated game may be a stand-alone wagering game.

In the illustrated bonus game, a player selects, one at a time, from the array of markers 94 to reveal an associated bonus-game outcome. According to one embodiment, each marker 94 in the array is associated with an award outcome 96 (e.g., credits or other non-negative outcomes) or an end-game outcome 98. In the illustrated example, a player has selected an award outcome 96 with the player's first two selections (25 credits and 100 credits, respectively). When one or more end-game outcome 98 is selected (as illustrated by the player's third pick), the bonus game is terminated and the accumulated award outcomes 96 are provided to the player.

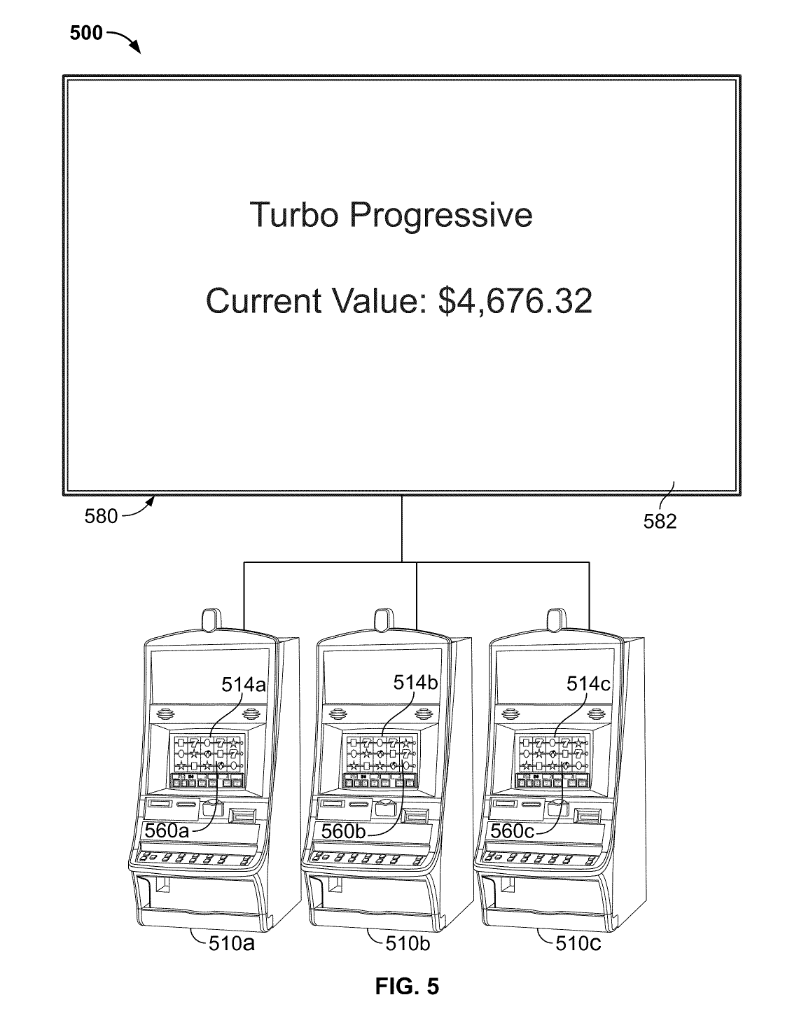

Turning to FIG. 5, a gaming system 500 having multiple wager levels eligible for progressive jackpots is displayed. The system 500 includes a plurality of gaming devices 510a,b,c, each of which include at least a primary display 514a,b,c for displaying game events thereon. Each of the primary displays 514a,b,c may be any form of display such as those described herein with reference to the free standing and handheld gaming devices of FIGS. 1a and 1b. The primary displays 514a,b,c may include a display of a primary wagering game 560a,b,c, which in this embodiment are slot games as shown in FIG. 5. The primary wagering games 560a,b,c may include a plurality of reels, which may be either electro-mechanical reels or simulations thereof on the primary display 514a,b,c. The reels may include a plurality of symbols thereon which vary as the reels are spun and stopped. The symbols may include any variety of graphical symbols, elements, or representations, including symbols which are associated with one or more themes of the gaming machines 510a,b,c or system 500. The symbols may also include a blank symbol, or empty space. The primary wagering games 560a,b,c shown on the various primary displays 514a,b,c of the system 500 may be the same, similar, or different in nature, game play, theme, denomination, formation, eligibility, etc.

As described herein, in some embodiments, symbols landing on the active pay lines (the pay lines for which a wager has been received) are evaluated for winning combinations. A combination of symbols that lands on an active pay line is a winning outcome for which an award may be paid in accordance with a payable of the gaming device 510a,b,c or system 500. The symbols on the reels form an array or matrix of symbols, having a number of rows and columns, which in the embodiment shown is three rows and five columns. In alternate embodiments, the array may have greater or fewer symbols, and may take on a variety of different forms having greater or fewer rows and/or columns. The array may even comprise other non-rectangular forms or arrangements of symbols. In alternative embodiments, other criteria may be used for winning combinations, such as symbol arrangement or configuration without regard to paylines.

The system 500 further includes a community display 580, which in this embodiment is an LCD, plasma, or other flat-screen display mounted and positioned above the plurality of gaming devices 510a,b,c. The community display 580 displays a community award in the form of at least one progressive award or progressive jackpot 582, and thus includes prize and award information related to the progressive jackpot 582. In the embodiment shown, the progressive jackpot 582 comprises an award which increments in response a plurality of players participating underlying primary wagering games 560a-c, and placing primary wagers thereon. As described herein, a portion of each primary wager received into the gaming system 500 contributes to a progressive jackpot increment amount, which causes the progressive jackpot 582 to increase in value, as displayed on the community display 580. In an embodiment, the progressive jackpot 582 continues to receive increment amounts, thereby increasing in value, until a triggering event occurs and the jackpot 582 is awarded to a player. When awarded, the progressive jackpot 582 is reset to a reset value, in an embodiment.

The display 580, in this example, communicates information concerning results and status of the progressive award 582. In an embodiment, the community display 580 displays a name of the progressive award, the current progressive award amount, and further announces the occurrence of a triggering event by displaying indicia indicating that the progressive award 582 has been awarded to a player. Alternatively, or additionally, information relevant to the progressive jackpot 582 may be displayed on the primary displays 514a-c, or on any other appropriate display.

The community display 580 may be placed in any appropriate place within a casino or operator's facility, for example, a gaming room in a casino, the entry area of a casino, elevators of a casino, or any other public place inside or outside of a casino. Publicly displaying progressive award information creates a community environment for gaming participants so as to incentive players to play games eligible for such progressive awards 582. Players may discuss their results or the results of others. Seeing and discussing the results of others may create an environment of friendly competition. This competition may spur some players to participate in more wagering game play in an effort to win the progressive award 582. This environment of community and competition may also create player loyalty. It should be noted that the information provided on the community display may be limited or delayed as desired by a casino or operator. For example, players' names, identifiers, and other information may be withheld from the community display so as to protect player anonymity.

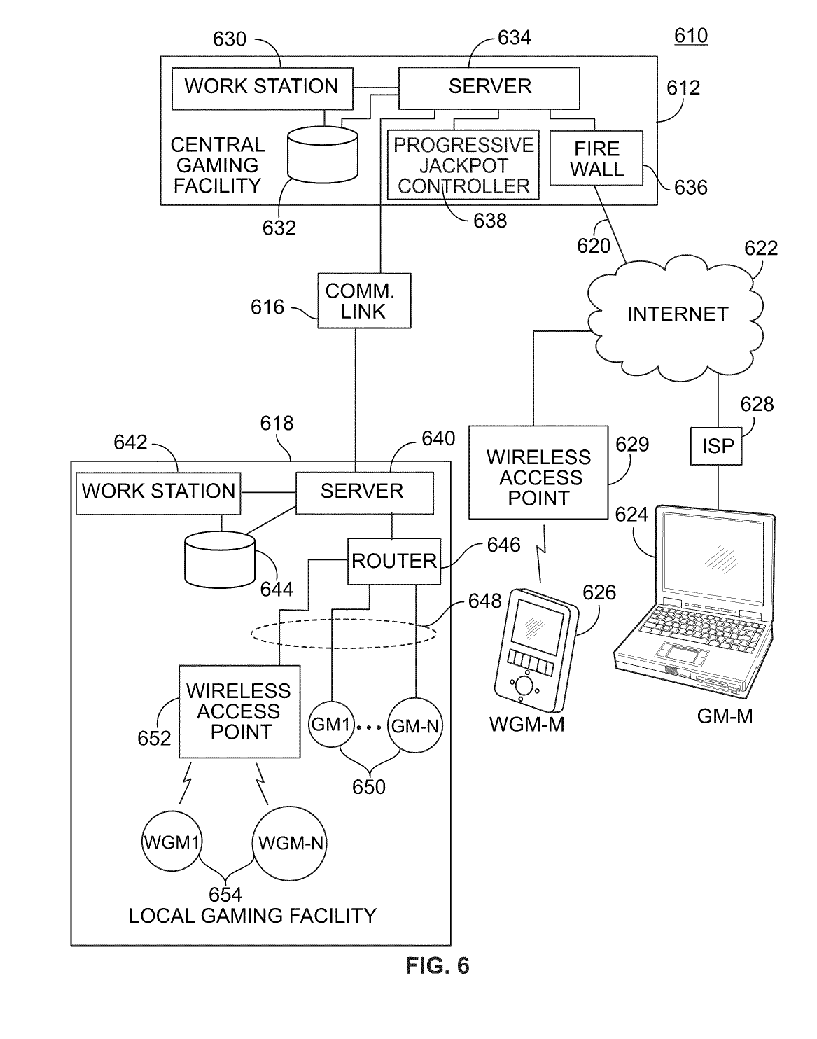

Turning to FIG. 6, a diagram of an example gaming system 600 having multiple wager levels eligible for progressive awards is depicted. Shown in FIG. 6, is an exemplary gaming system 610 which includes a central gaming facility 612 connected by communication link 616 to a local gaming facility 618 (e.g., a casino) and by link 620 with the internet 622. End-user computing devices including a gaming machine or terminal GM-M 624 (e.g., a laptop computer) and wireless gaming machine or terminal WGM-M 626 (e.g., a personal digital assistant (PDA)) function as clients of the central gaming facility 612. Laptop 624 is coupled via internet service provider 628 and the internet 622 with the central gaming facility 612. The PDA 626 is connected with a wireless link by the wireless access point 629 and internet 622 to the central gaming facility 612. As used herein, “gaming” refers to the use of various games that support the placing of wagers on the outcome of the games (e.g., a video poker machine).

The central gaming facility 612 may represent a control location of a gaming business operator that supports individual gaming users (e.g., users of PDA 626 and laptop 624) as well as other gaming facilities of the operator such as casino 618. The central gaming facility 612 in this illustrative example may be geographically separated from the casino 618 and the individual users. The central gaming facility 612 includes a workstation 630 supported by data storage element 632 and a server 634 that serves as a communication host for casino 618 and the individual users via a firewall 636. Requests for information and/or data received from the individual users are processed by the server 634. The requested information and/or data may be obtained from support resources (e.g., workstation 630) and data residing in storage element 632. The requested information is sent from the server 634 to the requesting user's device(s).

The local gaming facility 618 represents a casino and includes a server 640 supported by a workstation 642, data storage element 644, and a router 646. The router 646 supports communications with different gaming machines or terminals GM(1)-GM(N) 650 by wired links 648. A wireless access point 652 is connected by a wired link 648 to router 646 and by wireless communication links to wireless gaming machines or terminals WGM(1)-WGM(N) 654.

At least some of the gaming machines 650 and some of the wireless gaming machines 654 support the play of wagering games in which the user's gaming machine functions in the client/server communication model with the user's gaming machine being a client of server 640. The user's gaming machine contains software which is responsible for the ongoing play of the wagering game. However, some information or data associated with the play of the game may be obtained during the ongoing play of the game from server 640. Thus, the gaming system 610 displayed and described may be configured to execute and display a variety of primary wagering games and community or progressive wagering games on the terminals [GM(1)-GM(N) 650, WGM(1)-WGM (N) 654, GM-M 624, and WM-M 626], as explained further herein.

As seen in FIG. 6, the central gaming facility 614 may also include a dedicated progressive jackpot controller 638. The progressive jackpot controller 638 may be separate from or integrated with the server 634, or other servers of the facility 612. Moreover, the progressive jackpot controller 638 may be located in the local gaming facility 618, for example in communication with the local server 640. The progressive jackpot controller 638 and/or workstation 630 include software which operates to control, manage, execute, and operate the available progressive jackpots as described herein. For example, such software may log in users to the system, detect and catalog their play of primary wagering games, monitor their wager amounts and history, detect occurrences of jackpot triggering events, and award triggered jackpots to players. The progressive jackpot controller 638, for example, may permit players to access a player history file or profile to see past awards won, past results, etc. The progressive jackpot controller 638 may provide access to players within a casino or gaming facility over link 616, or may otherwise provide access to players remote from the gaming facility, for example over a home or mobile computer via link 620. It should further be understood that any of the functions described herein as relating to the central gaming facility 612 may alternatively or additionally be performed at the local gaming facility 618, or by any computer or server in communication therewith.

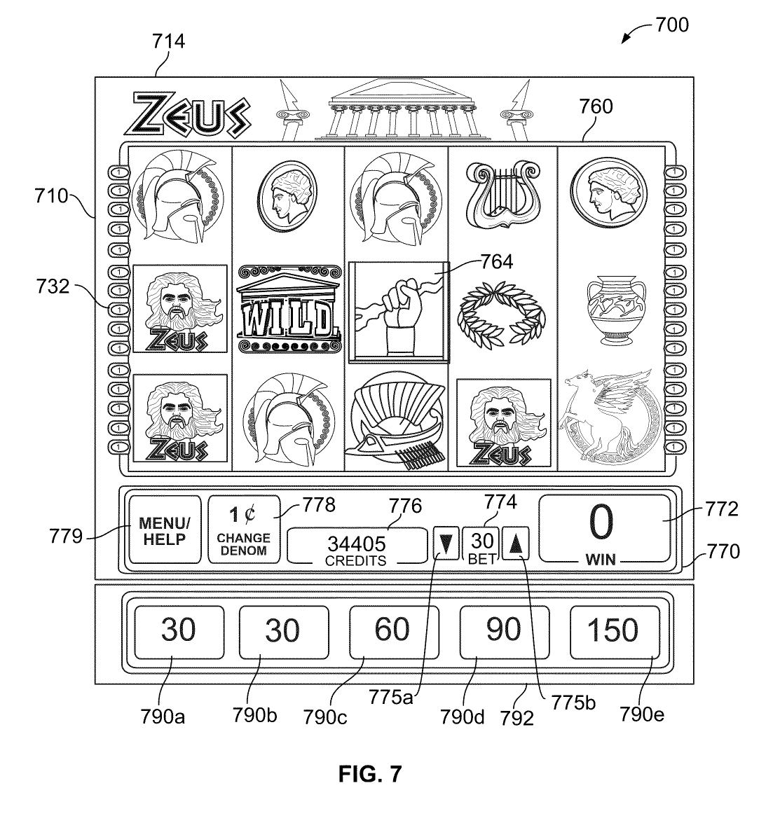

Turning to FIG. 7, a primary display 714 of a gaming terminal 710 of a gaming system 700 is displayed in which players may place different sized wagers which are eligible for participation in a progressive jackpot award. Displayed on the primary display 714 is a primary wagering game 760. The primary wagering game 760 is a slot reel game, such as those depicted and described with reference to FIGS. 1a, 1b, and 5. In this embodiment, two input devices are provided to a player: a control panel 770 along a bottom of the display 714, and a plurality of buttons 790a-e housed on a button panel 792. The button panel 792 may be mounted on any appropriate place on the gaming device 710, such as below the primary display 714.

The control panel 770 includes a win meter 772, a bet meter 774, bet adjustment controls 775a,b, a credit meter 776, a denom button 778 and a menu/help button 779. The win meter 772 displays to the player an amount of credits won on a previous play of the wagering game 760. Thus, as seen in FIG. 7, on losing plays the wagering game 760, the win meter 772 displays zero. The credit meter 776 displays a balance of remaining credits available to a player of the gaming terminal 710. Wins received and displayed in the win meter 772 are transferred or credited to the credit meter 776 while wagers placed on subsequent plays of the wagering game 760 are debited from the credit meter 776. The denom button 778 allows a player to chance the base denomination that he is playing, and displays the value of one credit (which in this instance is one cent). Thus, for each credit wagered, one penny ($0.01) is being wagered. The menu/help button 779 provides access to further help and menu screens for a variety of other functions, including learning more about the play of the wagering game 760, and selecting various preferences related thereto.

The bet meter 774 and adjustment controls 775a,b permit a player to see his current wager level and adjust the amount of credits that he is wagering on each play of the wagering game 760. The bet meter displays the current wager amount, which in this instance is 30 credits (one credit wagered on each activated payline). As seen by the payline markers 732 on the left and right edges of the display, this wagering game 760 includes a total of thirty (30) paylines 732 which the player may activate. In an embodiment, the player must activate all available paylines 732 in order to be eligible for participation in bonus or secondary events, such as the progressive jackpots described herein. The adjustment controls 775a,b may be used by a player to either increase his wager (using the up arrow control 775b) or decrease his wager (using the down arrow control 775a). In an embodiment, the available wager amounts are discrete predefined wager amounts. In an alternative embodiment, the player may select any wager amount within a range of available wager amounts.

The button panel 792 further provides an alternative method by which a player can adjust his wager amounts. In one embodiment, a plurality of wager buttons 790a-e may be provided which correspond with a plurality of discrete permissible wagers. Thus, as seen in FIG. 7, the five buttons 790a-e are labeled with wager amounts which they represent. The first button 790a corresponds to a wager of 30 credits (1 credit per activated payline). The second button 790b corresponds to a wager of 60 credits (2 credits per activated payline). The third button 790c corresponds to a wager of 90 credits (3 credits per activated payline). The fourth button 790d corresponds to a wager of 150 credits (5 credits per activated payline). The fifth button 790e corresponds to a wager of 300 credits (10 credits per activated payline). In an embodiment, pressing one of the buttons 790a-e causes the corresponding wager to be placed on the next play of the wagering game 760, and is reflected in the bet meter 774. In an alternative embodiment, pressing one of the buttons 790a-e both adjusts the wager amount and acts as a “spin” button so as to initiate the next play of the wagering game 760, for example causing the reels to commence spinning.

In operation, a progressive jackpot controller (such as the one described in reference to FIG. 6) in communication with each eligible gaming terminal controls and administers available progressive jackpots. The progressive controller receives wager information from each gaming terminal and uses such information to calculate an increment amount to be added to the current progressive award. The increment comprises a percentage of each wager received for play of a primary wagering game on a gaming terminal which is used to increase, or increment the progressive jackpot. In addition, the progressive controller monitors the occurrence of jackpot triggering events. In one embodiment, a jackpot triggering event comprises four or more like “Jackpot” symbols aligning on an activated payline in a primary wagering game 760. For example, in FIG. 7, the “Lightning in Fist” symbol 764 (third symbol in second row) is a jackpot symbol, and four or more such symbols 764 landing on an activated payline trigger an award of the progressive jackpot. In an alternative embodiment, the Jackpot Symbols may be evaluated on a scatter pay basis, which is without regard to their position relative to activated paylines. In such an embodiment, four or more “Lightning in Fist” symbols 764 landing anywhere in the array of symbols trigger the progressive jackpot.

Once triggered, the progressive jackpot award is awarded to the player at the gaming terminal who caused the triggered event. Thus, a player who achieved the four Jackpot Symbol pay, as described above, would receive the then-current balance of the progressive jackpot, as displayed on the jackpot meter. The progressive jackpot would then be reset to a reset value (R) by the progressive controller. Once reset, future wagers received would continue to build up the progressive jackpot again, in the same fashion, by deducting an increment amount from each wager and contributing such increment to a total collected increment causing the progressive award to grow.

Following is a description of how the gaming system performs accounting functions related to the progressive jackpot to ensure fairness amongst players placing different sized wagers. In an embodiment, the progressive controller receives wager information, and deposits increment amounts therefrom into various virtual accounts (referred to herein as “bins”) to account for various sizes of wagers received. Such a method is used to ensure consistent expected value for all wager levels. Thus, assume that each gaming terminal in the gaming system provides the same available wagering levels. In an embodiment, assume the gaming system has available N wagering levels, where each successive wagering level is greater than the one before it: W<W₂< . . . <W_{N}. In such a configuration, the system utilizes N virtual depositories or “bins” which store received increment. The bins correspond to the available wager levels, and thus are referred to as: B₁, . . . , B_{N}. The bins are stored in appropriate memory accessible by the progressive jackpot controller for easy recall. The progressive award, as discussed, has a reset value (“R”), which in an embodiment is associated with the lowest, or minimum wagering level W₁. The progressive control utilizes an increment rate (“r”) which is a percentage applied to received wagers and dedicated toward incrementing or advancing the size of the progressive award. As discussed, a player may wager any amount on any play of the wagering game, and thus may select from any of the available wager amounts: W₁<W₂< . . . <W_{N}.

In general terms, if a player bets at a wager level Wⱼ, then the first j bins will receive increment contributions. That is, the total increment deducted from such wager Wⱼ is divided and deposited into various bins, depending upon a size of the wager Wⱼ. The amount added to B₁ is

r*W₁

For 1<i≦j, the amount added to the bin Bᵢ is given by:

r*(Wᵢ−Wᵢ₋₁)

Thus, a portion of the wager is deposited into each bin up to and including the bin Bⱼ associated with the size of the wager Wⱼ. By dividing increment received into the various bins, the accounting function of the gaming system is able to track the amount of increment received from each sized wager. Once a triggering event occurs, the progressive jackpot is awarded to a player of the gaming terminal upon which the triggering combination occurred. However, the amount awarded to the player depends upon a size of the wager that the player placed on the play of the game triggering the progressive award. Thus, described generally, a player betting at level Wⱼ who triggers wins the progressive award on such play, is awarded a scaled progressive award based on the size of his wager. In an embodiment, the scaled progressive award comprises a scaled reset value plus the amounts contained in the first j bins, for a player placing a wager Wⱼ.

Thus, the formula for the scaled progressive award provided to a player making a wager of Wⱼ on the play of the wagering game triggering the progressive award is given by:

Scaled Progressive Award=└(Wⱼ/W₁)×R┘+B₁+ . . . +Bⱼ Equation 1

In this formula, B₁ represents the balance of increment collected and stored in the first bin, and Bⱼ represents the balance of increment collected and stored in the jth bin.

In such an embodiment, a player making a minimum wager W₁ receives an amount equal to the reset value (R) plus all increment collected and stored in the first bin B₁. Similarly, a player making a maximum wager W_{N} receives a higher scaled amount which is equal to a multiple

$$( \frac{{W}_{N}}{{W}_{1}} )$$

of the reset value (R), plus all increment collected and stored in all of the bins B₁ . . . B_{N}. Players wagering more than the minimum but less than the maximum receive scaled progressive awards in accordance with the formula, and the amounts from some of the bins (the first bin through the jth bin). If a less than maximum wager triggers the jackpot, then bins which are not awarded (Bⱼ₊₁ through B_{N}) are held over and maintain their balances for a subsequent jackpot award. Similarly, bins which are awarded (B₁ through Bⱼ) are zeroed out, or cleared, and begin collecting increment again with the subsequent jackpot award.

Thus, as can be seen, in such a system, when a player makes a wager on a play of the wagering game, a percentage of his wager is dedicated to funding the progressive award, in the form of an increment rate (r). The entire amount of such increment received from any particular wager is deposited in at least the first bin (for a minimum wager), and in a plurality of the bins (for a greater than minimum wager). Thus, since the bins (other than the first bin) are funded by wagers greater than the minimum, those bins contain additional funds with which to pay the scaled progressive award when triggered. In this way, the described gaming system provides the desirable result that the probability of triggering the jackpot award and the expected value of a jackpot award are not dependent upon wager level. Additionally, the gaming system described includes an increment amount that depends on wager levels, which means that the amount of increment amount collected with each wager increases with increasing wager levels (the more wagered by a player, the more increment collected).

An example configuration of such a gaming system is given below, and corresponds with the system and terminals depicted and described in FIGS. 5-7. In this example embodiment, gaming terminals in the system include five discrete wagering levels. A player may wager 30, 60, 90, 150, or 300 credits (corresponding to wager levels W_{z}, W₂, W₃, W₄ and W₅, respectively) as depicted on the button panel of FIG. 7. Thus, five bins (B₁, B₂, B₃, B₄, and B₅) are used in which increment amounts are collected and stored. A reset value (R) is configured into the system, which in this embodiment is four hundred times the minimum wager (400×W₁), which in this embodiment is 12,000 credits (400×30 credits). In this embodiment, a one-cent denomination (such as that shown in FIG. 7) is used. This corresponds to the wager amounts being 30, 60, 90, 150, and 300 cents respectively, and a reset value of 12,000 cents, or $120.00. In other embodiments, other denominations may be employed.

The bins are filled as described above. For a minimum wager of 30 credits, the entire increment amount is deposited into the first bin B₁. For a second level wager of 60 credits, in accordance with the formulas herein, a first portion of the increment is deposited into the first bin B₁ while a second portion is deposited into the second bin B₂. This depositing of increment amount distributed amongst various bins continues in a similar fashion for increasingly larger wagers. For a player wagering a maximum wager of 300 credits, the bins (B₁, B₂, B₃, B₄, and B₅) would be incremented according to the following formulas:

B_{1new}=B_{1old}+r*30

B_{2new}=B_{2old}+r*30

B_{3new}=B_{3old}+r*30

B_{4new}=B_{4old}+r*60

B_{5new}=B_{5old}+r*150

Thus, assuming in this example an increment rate of one percent (1%), for a player making a maximum wager of 300 credits, the total increment would be 3.00 credits, which would be deposited into the bins as follows: B₁ would receive 0.30 credits, B₂ would receive 0.30 credits, B₃ would receive 0.30 credits, B₄ would receive 0.60 credits, and B₅ would receive 1.50 credits. For a player making a minimum wager of 30 credits, the entire increment amount of 0.03 credits would be deposited in the first bin B₁. Thus, as can be seen, larger wagers generate larger increment amounts which are added to more bins, while smaller wagers generate smaller increment amounts which are added to fewer bins. This assists the gaming system in providing larger awards to larger wagering players (using the Scaled Progressive Award formula) while still maintaining sizeable awards for lower wagering players.

Additionally, a portion of the Scaled Progressive Award, as seen in the in Equation 1, is dependent upon the reset value (R) and the size of the wager when the jackpot was triggered relative to the minimum wager. In this embodiment, if a player triggers the jackpot with a minimum wager, he receives the reset value R (plus appropriate bin amounts as described). If he triggers the jackpot with a greater-than-minimum wager, he receives a multiple of the reset value R (plus appropriate bin amounts). The multiples are ratios of the triggering wager amounts to the minimum wager amount. In this example, such scaled resets are R, 2×R, 3×R, 5×R and 10×R, for the five wager levels 30, 60, 90, 150, and 300 credits, respectively.

Thus, the system distributes increment amounts received from wagers into a variety of bins based upon a size of the wager from which the increment was received. Additionally, the system awards a scaled progressive award based upon a size of a wager played on a primary wagering game during which the progressive award is triggered.

In an alternative embodiment, the gaming system may employ a plurality of jackpots, such as a multi-level progressive game. In such an embodiment, the various progressive jackpots may have different reset values and different increment amounts assigned to them, such that generally the plurality of awards are different in magnitude. For example, the awards may comprise a “Gold” level jackpot, a “Silver” level jackpot, and a “Bronze” level jackpot, having reset values of $10,000, $1,000, and $100, respectively. The progressive controller may be configured so as to apportion increment received amongst the various available progressive jackpots in a similar manner as described herein. Thus, each of the plurality of jackpots may be configured with a reset value and a plurality of bins which collect relative portions of increment from wagers received. The various jackpots may increase in value as increment is received, and may be displayed on the primary display of a gaming terminal, or on a community display such as the one depicted in FIG. 5. The various progressive jackpots may be awarded in response to different triggering events (independent of each other). Alternatively, the progressive jackpots may be awarded in response to a single triggering event, as described herein, followed by a secondary decision as to which jackpot is awarded (e.g., a random selection from a weighted probability table, once the award is triggered). Other configurations are possible as well.

In an embodiment, the progressive jackpot displayed to a player is the scaled progressive award for a maximum wager. Thus, for example, the community display of FIG. 5 may display a progressive award amount which corresponds to the then current total of the reset value (R) and the amount stored in the all of the bins (B₁ through B_{N}). Such a representation would depict a maximum progressive award which would be won by any player, and thus may add excitement and further incentivize players to participate in wagering games eligible to win such progressive award. In an alternative embodiment, the progressive jackpot displayed to a player may be the scaled progressive award for a minimum wager, corresponding to the then current total of the reset value (R) and the amount stored in the first bin (B₁). In yet another alternative embodiment, a scaled progressive award could be displayed to a player, for example, on the primary display of the gaming terminal at which he is playing. Thus, such a terminal could adjust and display a scaled progressive award based upon the then-current wager being played by the player. Since the scaled progressive award equation (Equation 1) dictates that the scaled progressive award is dependent upon wager size, by knowing the size of the wager being played, the system may display to the player a customized scaled progressive award based upon their then-current play. For example, a player making a maximum wager could see a running incrementing jackpot meter which includes a scaled reset value and the sum of all of the bins. Similarly, a player making a level three wager, for example, could see a scaled reset value and the sum of the first three bins. Other configurations are possible.

In an embodiment, certain eligibility requirements may be required to be met before a player is eligible to participate in winning the progressive awards. For example, a player may be required to place a bet on all available paylines (i.e., activation of all paylines requirement) in order to be eligible for the progressive award. Therefore, although the player may place any sized wager on each payline, he or she may be required to place at least a minimum wager (e.g., 1 credit) on each payline. In one embodiment, preset wager levels account for this “all paylines activated” eligibility requirement. For example, all of the preset wager buttons 790a-e in FIG. 7 place at least one credit on each payline, thereby satisfying the eligibility requirements. Therefore, in an embodiment, the preset wager buttons may facilitate a player's ability to easily meet such eligibility requirements.

The gaming system and methods of the present invention offer a number of benefits to players and operators. Players playing wagering games are eligible to participate in one or more progressive awards regardless of their wager level. This instills a sense of fairness and equality amongst players. Additionally, higher wagering players are able to earn enhanced awards to compensate for their higher wagers, again ensuring fairness. Thus, such a system simultaneously provides exciting and entertaining game play to players of all wager levels. Other benefits are provided as well.

Each of these embodiments and obvious variations thereof is contemplated as falling within the spirit and scope of the claimed invention, which is set forth in the following claims.

What is claimed is:

1. A method of conducting a wagering game having a scaled progressive award, comprising:
receiving a first wager from a player;
displaying a first play of a primary wagering game;
calculating an increment of the first wager in accordance with an increment rate;
if the first wager is equal to a minimum wager, depositing the increment into a first bin;
if the first wager is greater than a minimum wager, depositing a first portion of the increment into the first bin and a second portion of the increment into a second bin; and
upon the occurrence of a triggering event, awarding a scaled progressive award comprising a sum of a reset value, the first bin, and any additional bins for which the player qualifies.

2. The method of claim 1, wherein the additional bins for which the player qualifies is based upon a size of a subsequent wager placed on a subsequent play of the wagering game during which the triggering event occurred.

3. The method of claim 2, the first wager is selected from a group of available wagers, the group comprising X different wager amounts.

4. The method of claim 3, wherein the first and second bins are selected from a group of Y available bins.

5. The method of claim 4, wherein X equals Y.

6. The method of claim 1, wherein the first portion comprises the product of the minimum wager and the increment rate.

7. The method of claim 1, wherein the second portion is calculated as:
increment rate*(first wager−minimum wager).

8. A method of conducting a wagering game having a scaled progressive award, comprising:
receiving a first wager from a player, the first wager selected from a group of N available wager amounts;
displaying a first play of a primary wagering game;
calculating an increment of the first wager in accordance with an increment rate;
if the first wager is equal to a minimum wager, depositing the increment into a first bin of N bins;
if the first wager is greater than a minimum wager, depositing a first portion of the increment into the first bin and a remainder of the increment into at least one of the remaining N bins; and
upon the occurrence of a triggering event, (i) determining a size of a second wager placed on a subsequent play of the wagering game during which the triggering event occurred, and (ii) awarding a scaled progressive award, the scaled progressive award dependent upon the size of the second wager.

9. The method of claim 8, wherein the N available wager amounts are ordered from lowest to highest from the minimum wager (W₁) to a maximum wager (W_{N}).

10. The method of claim 9, wherein the N bins are ordered from the first bin (B₁) to a last bin (B_{N}), wherein each bin is associated with a corresponding wager amount.

11. The method of claim 10, wherein the first bin (B₁) is associated with the minimum wager (W₁) and the last bin (B_{N}) is associated with the maximum wager (W_{N}).

12. The method of claim 11, wherein the scaled progressive award for the second wager (Wⱼ) is calculated as: └(Wⱼ/W₁)×R┘+B₁+ . . . +Bⱼ, wherein R is a predetermined reset value.

13. The method of claim 12, further comprising resetting a progressive jackpot display to the reset value and clearing all bins awarded as part of the scaled progressive award.

14. A gaming system comprising:
a wager input device;
at least one display for displaying a primary wagering game and value of a progressive jackpot; and
at least one controller operative to:
(i) detect receipt of a first wager from a first player;
(ii) cause the at least one display to display a first play of the primary wagering game;
(iii) calculate an increment of the first wager in accordance with an increment rate;
(iv) if the first wager is equal to a minimum wager, deposit the increment into a first bin;
(v) if the first wager is greater than a minimum wager, deposit a first portion of the increment into the first bin and a second portion of the increment into a second bin; and
(vi) upon the occurrence of a triggering event, award a scaled progressive award comprising a sum of a reset value, the first bin, and any additional bins for which the player qualifies.

15. The gaming system of claim 14, wherein the additional bins for which the player qualifies is based upon a size of a subsequent wager placed on a subsequent play of the wagering game during which the triggering event occurred.

16. The gaming system of claim 15, wherein the value of the progressive jackpot comprises a sum of the reset value and the first bin.

17. The gaming system of claim 15, wherein the value of the progressive jackpot comprises a sum of the reset value, the first bin, and any additional bins for which the player qualifies.

18. The gaming system of claim 14, wherein the first portion comprises the product of the minimum wager and the increment rate.

19. The gaming system of claim 14, wherein the second portion is calculated as:
increment rate*(first wager−minimum wager).

20. A gaming system comprising:
a plurality of gaming terminals, each gaming terminal comprising a display for displaying a primary wagering game;
at least one wager input device for receiving wagers from players at the plurality of gaming terminals;
at least one community display from displaying a value of a progressive jackpot; and
at least one controller operative to:
(i) detect receipt of wagers from the players, each such wager selected from a group of N available wager amounts;
(ii) calculate an increment of each wager received in accordance with an increment rate;
(iii) if a received wager is equal to a minimum wager, deposit the increment into a first bin of N bins;
(iv) if a received wager is greater than a minimum wager, deposit a first portion of the increment into the first bin and a remainder of the increment into at least one of the remaining N bins; and
(v) upon the occurrence of a triggering event, (i) determine a size of a final wager placed on a subsequent play of the wagering game during which the triggering event occurred, and (ii) award a scaled progressive award, the scaled progressive award dependent upon the size of the final wager.

21. The gaming system of claim 20, wherein the N available wager amounts are ordered from lowest to highest from the minimum wager (W₁) to a maximum wager (W_{N}).

22. The gaming system of claim 21, wherein the N bins are ordered from the first bin (B₁) to a last bin (B_{N}), wherein each bin is associated with a corresponding wager amount, such that wager amount Wⱼ is associated with bin Bⱼ.

23. The method of claim 22, wherein the first bin (B₁) is associated with the minimum wager (W₁) and the last bin (B_{N}) is associated with the maximum wager (W_{N}).

24. The method of claim 23, wherein the scaled progressive award for a selected wager amount Wⱼ is calculated as: └(Wⱼ/W₁)×R┘+B₁+ . . . +Bⱼ, wherein R is a predetermined reset value.

25. The method of claim 24, further comprising resetting a progressive jackpot display to the reset value and clearing all bins awarded as part of the scaled progressive award.

26. The gaming system of claim 20, wherein the value of the progressive jackpot comprises a sum of the reset value and the first bin.
